(19) United States
(12) Patent Application Publication
(10) Pub. No.: US 2004/0131027 A1
(43) Pub. Date: Jul. 8, 2004

(54) Method for gain control and corresponding receiving unit

(76) Inventors: Jouko Lokio, Espoo (FI); Niko Kiukkonen, Veikkola (FI); Jari Junell, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/250,321

(22) PCT Filed: Oct. 29, 2001
(86) PCT No.: PCT/EP01/12500

(51) Int. Cl. H04Q 7/00

(52) U.S. Cl. 370/329; 370/278

(57) ABSTRACT

The invention relates to a method for controlling a gain applied to signals which are transmitted by a transmitting unit via an air interface and received by a receiving unit. In order to overcome problems resulting from varying power levels of signals received by the receiving unit, it is proposed that it is determined before reception by said receiving unit for at least some of to be received signals an expected power level in said receiving unit. The determination is based on parameter values used by said transmitting unit for setting a transmission power for said at least some of said to be received signals and which are known at the receiving unit. The gain is then adjusted based on said determined expected power level. The invention equally relates to a receiving unit with corresponding means, and to a communications network and a communications system comprising such a receiving unit.

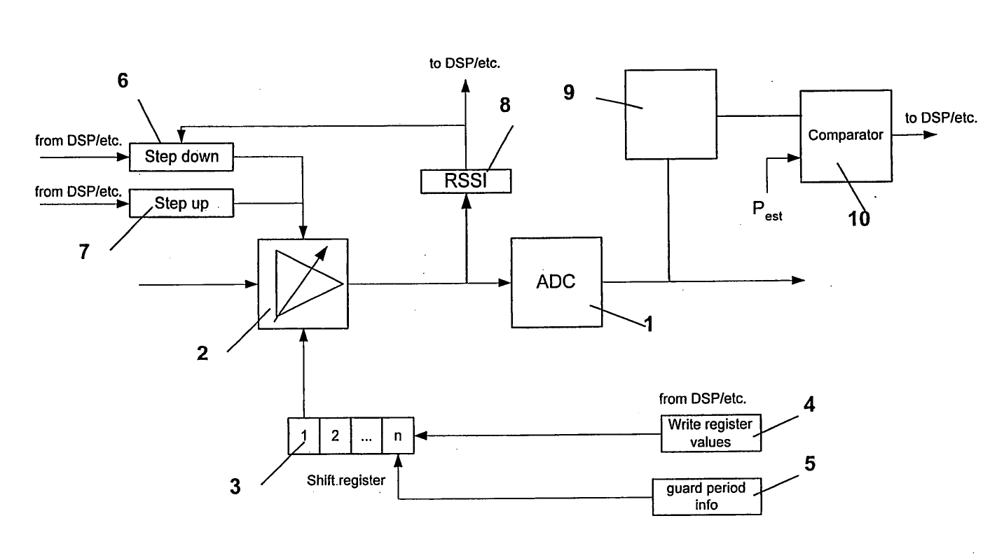

### FIELD OF THE INVENTION

The invention relates to a method for controlling a gain applied to signals transmitted by a transmitting unit via an air interface and received by a receiving unit. The invention equally relates to such a receiving unit, as well as to a communications network and communication systems comprising such a receiving unit.

### BACKGROUND OF THE INVENTION

When signals are transmitted with a balanced power level from a transmitting unit to a receiving unit, the power level of the received signals can vary significantly due to unpredictable conditions on the transmission path. This varying power level can have a negative impact on further processing of the signals.

In a wideband code division multiple access (WCDMA) time division duplex (TDD) base station receiver, which receives uplink signals transmitted by user equipment in time slots, for example, the power of signals received in consecutive time slots can vary by tens of dBs. When designing an analogue-to-digital converter (ADC) used in a such a base station receiver for converting received analogue signals into digital signals, the varying power levels have to be taken into account, since the ADC has a predefined range. The input signal range of the ADC can typically vary from the thermal noise power level to the power level of the strongest blocking signals. A small range might be sufficient for frequency division duplex (FDD) transmissions, which have a good spreading gain resulting throughout in signals below the thermal noise level. Since the spreading gains are smaller in TDD mode than in FDD mode, however, the signals in TDD are often above thermal noise level at the input of the ADC. Moreover, FDD has a continuous transmission so that there is rarely a drastic change from time slot to time slot. In TDD, also interference coming from adjacent TDD cells or frequencies has a slotted nature so that also the interference level can change significantly from time slot to time slot.

In a first known solution, the varying power levels of received signals are taken into account of by using ADCs with a wide enough range, a power balancing being carried out only on the digital side. The additional dynamic range of the ADC required exclusively due to changes in the power level of received signals can be easily 5 bits. This can lead for example to an ADC with a total of 13 bits of resolution. Since the performance of a real ADC is not ideal, there have to be moreover some extra bits, leading to converters of e.g. more than 14 bits, which are quite expensive and lead to a space consuming implementation.

Even if the technical development might result in a cheaper and smaller design of ADCs, the dynamic range of the ADC has still to be very large in order to be able to convert signals with significantly varying power levels. A large dynamic range corresponds to large digital word lengths, which increases the need for buffering and requires more complicated interfaces etc.

In an alternative solution, a stepping algorithm is used for setting the power level of received signals within each time slot with an automatic gain control (AGC) before feeding the signals to the ADC. However, it is necessary to find the optimal input level for the automatic gain control (AGC), which determines the gain applied to the received signals, as soon as possible, since in TDD there are no dummy bits. The information rather starts right from the beginning of the slot. Since the channel estimation is normally done over the whole time slot, the gain setting should be constant over this slot. A stepping algorithm is too slow to cover the whole possible range of the power level for setting the required gain in the required time. Thus, when using only a stepping algorithm for setting the gain, there will be a performance loss in the beginning of the slot until the AGC has found the right level. This degrades the bit error rate (BER) and makes the overall performance worse.

### SUMMARY OF THE INVENTION

It is an object of the invention to overcome problems resulting from varying power levels of signals received by a receiving unit.

The object is reached with a method for controlling a gain applied to signals transmitted by a transmitting unit via an air interface and received by a receiving unit, which receiving unit has knowledge of parameter values used by the transmitting unit for setting a respective transmission power. The proposed method comprises in a first step determining before reception by said receiving unit for at least some of to be received signals an expected power level in the receiving unit based on its knowledge of parameter values used by the transmitting unit for setting a transmission power for the at least some of the to be received signals. The proposed method further comprises adjusting the gain which is to be applied to the at least some of the received signals based on the determined expected power level.

The object is equally reached with a corresponding receiving unit which comprises means for realizing the steps of the proposed method. These means include in particular an automatic gain control unit for applying an adjustable gain to received signals, means for determining in advance an expected power level of at least some of received signals, and means for adjusting the gain applied by the means for applying a gain to received signals.

Further, a communications network and a communications system are proposed, which comprise at least one such receiving unit.

The invention proceeds from the idea that information available at and/or made available to the receiving unit can be used for determining an expected power level of signals that will be received. Depending on the available information, this expected power level can be rather close to the actual power level of the received signals. The expected power level can therefore be exploited for determining a suitable gain applied to the received signals when they have been received.

Thus, the invention allows a presetting of the applied gain already before the concerned signals are received, which enables a fast adaptation to the required gain.

It is to be noted that the gain can also be set to the right level in case there is no signal to receive or if it is not known whether a signal is received on a channel for which a power estimation is possible.

Preferred embodiments of the invention become apparent from the dependent claims.

In one preferred embodiment of the invention, the expected power level of signals that are to be received is determined based in addition on values measured for preceding signals received at the receiving unit. Such values can be in particular interference levels measured at the receiving unit. Alternatively or in addition, other measured values from preceding signals, in particular previous frames, can be used for determining an expected power level. For example, the power levels for the corresponding slots in previous frames can be used for determining an expected power level, in particular in case no changes in the number of users or codes are expected.

Parameter values employed by a transmitting unit for setting a transmission power can be known at a receiving unit in particular because the values were provided by the receiving unit to the transmitting unit. In case the receiving unit is a base station receiver and the at least one transmitting unit is at least one user equipment, the parameter values employed by a user equipment and known at the base station receiver can comprise in particular the number of physical channels employed by the user equipment, an SIR target value assigned to each of the physical channels and one or more constant values, which constant values might include transmit power control (TPC) constant values.

In a further preferred embodiment, the signals are transmitted via the air interface in time slots, as in a time division multiple access (TDMA) system. The invention is of particular advantage for environments where the number of users/channels and/or interference levels can change significantly from time slot to time slot. In TDD systems using time slots, path loss measurements carried out by the transmitting units, e.g. by user equipments, can be particularly accurate. If such path loss measurements are taken into account by the respective receiving unit for determining the actual transmission power, the power estimate at the receiving unit, e.g. a base station receiver, will also be more accurate than in FDD systems. Thus the open loop power control error is smaller in TDD systems, resulting in a more accurate adjustment of the gain.

Interference levels to be used for determining the gain that is to be applied can then be measured by the receiving unit on each time slot of a respective preceding frame.

The gain to be applied can moreover be determined individually for each time slot, for instance for each time slot used for a dedicated physical channel (DPCH). A gain value identifying the to be applied gain for one time slot respectively is in addition advantageously determined for several time slots in advance, in order to avoid problems resulting from a delay in the transmission from the entity in which the values are determined and the entity by which the gain is applied. In case several determined gain values are supplied together, these values can be stored in a register, e.g. a shift register. The gain values can then be consecutively output by the register to the entity applying the gain to the received signals for setting the gain correctly for each time slot.

If the signals are transmitted in time slots, and the receiving unit is a receiving unit of a communications network, the gain values identifying the gain to be applied to signals received in uplink time slots are advantageously provided during the transmission of signals in downlink time slots.

For time slots for which the received signal power level cannot be estimated in advance, a supplementary special treatment can be provided. Such time slots can be in particular random access time slots of a Random Access Channel (RACH), random access being described for example in the technical specification 3GPP TS 25.224, V4.0.0: “3rd Generation Partnership Project; Technical Specification Group Radio Access Network; Physical Layer Procedures (TDD)”. The RACH is an up link transport channel that is used to carry control information from user equipment to a base station. The RACH may also carry short user packets. For the RACH, the transmit power level is determined by each user equipment based on the measured power of the received signals, to which measured power a constant value received by the base station is added. The power level in the RACH time slots varies more than during normal transmission. If a RACH is not successfully received in the base station, it is sent again after a random period. For time slots where RACH can be used it is possible to estimate how many RACHs there are. When determining the expected power level, this estimated number of channels is taken account of.

In many cases the estimation of the power level of signals that will be received will be good enough to form the only basis for a gain adjustment. If required, however, an additional adjustment proceeding from the preset gain value is possible. Such an addition adjustment can be realized for instance as stepping algorithm. Following the presetting of a close to optimal gain value, an adaptation with a stepping algorithm is now possible, since the remaining error is only due to a power control error and should be quite small. For the stepping algorithm, any known method can be employed, for example the method described in PCT application WO 0 030 260, published May 25, 2000.

If a stepping algorithm is employed, it can also be used for determining a more accurate initial gain setting value. For example, if the gain has always to be adjusted in upward direction, it is clear that there is a systematic error which can be corrected, resulting in a self-remediable system.

In an alternative or additional approach for a self-remediable system, the determined expected power level for received signals is compared to the real power levels of these received signals. The resulting difference can then be considered as a systematic gain error that might be corrected in the subsequent determination of expected power levels or in the corresponding adjustment of the gain.

The invention is particularly suited to provide a received signal with a balanced power level to an ADC of a receiving unit like a base station receiver. If the received signals are provided to the ADC with a reduced power range, as enabled by the invention, an ADC with a smaller resolution can be used, which enables in turn a smaller and cheaper implementation. Moreover, the interface between the ADC and the digital baseband can be designed more simple.

The invention can be employed advantageously, though not exclusively, for WCDMA, in particular WCDMA TDD. The invention can also be employed for instance in the global system for mobile communications (GSM).

### BRIEF DESCRIPTION OF THE FIGURES

In the following, the invention is explained in more detail with reference to a FIGURE which shows a block diagram of an embodiment of the invention.

### DETAILED DESCRIPTION OF THE INVENTION

The only FIGURE shows an embodiment of the invention implemented in a WCDMA TDD base station receiver. The invention is employed for providing received uplink signals, which were transmitted by user equipments, with a balanced power level to an analogue-to-digital converter ADC 1 of the base station receiver. Even though features of the invention are depicted as blocks, the implementation of the invention requires only changes to the software on the digital side of the base station receiver.

In the FIGURE, the input of an automatic gain control unit AGC 2 is connected to receiving means of the base station receiver (not shown), and the output of the AGC 2 is connected to the ADC 1. The AGC 2 has further two controlling inputs.

A first controlling input is connected to a shift register 3. The shift register 3 in turn is connected to functions of a digital signal processor (DSP) of the base station receiver, which functions are suited for writing register values 4 and for providing a guard period information 5.

The second controlling input of the AGC 2 is connected on the one hand to a first control line including a step down function 6 and on the other hand to a second control line including a step up function 7. The DSP has a controlling access to the step down and the step up function 6, 7, even though this is not necessarily required. The first control line is additionally in contact with the output of the AGC 2 via an analogue received signal strength indicator (RSSI) 8. The output of the RSSI 8 is further provided to the DSP.

The output of the ADC 1 is forwarded on the one hand for further signal processing, and on the other hand to an assembly of blocks provided for a correction of systematic gain errors in the analogue receiver chain. In this assembly, the output of the ADC 1 is connected via measuring means 9 and a first input of a comparator 10 to the DSP. A predetermined value can be input to a second input of the comparator 10.

Instead of a DSP, any other technology suitable for digital signal processing can be employed.

Signals received by the receiving means of the base station receiver via the air interface are fed to the AGC 2. The AGC 2 amplifies the received signals with the currently set gain and forwards them to the ADC 1 for analogue-to-digital conversion for further use.

The desired power level input to the ADC 1 and thus the required gain applied by the AGC 2 to incoming signals is calculated for each time slot by the DSP. The required gain of the AGC 2 is then set by providing a corresponding gain setting value to the first control input of the AGC 2. Each gain setting value is determined from the difference between the desired power level at the input to the ADC 1 and an expected power level of received signals. The expected power level can be estimated by the DSP of the base station receiver based on its knowledge of parameter values employed by the respective user equipment as will be explained in the following.

In the presented embodiment of the invention, the uplink transmission power is controlled on the network side separately for each Dedicated Physical Channel (DPCH) with an open loop scheme. Open loop power control is described for example in the technical specification 3GPP TS 25.331 V3.5.0 (2000-12): “3rd Generation Partnership Project; Technical Specification Group Radio Access Network; RRC Protocol Specification (Release 1999)” which is incorporated by reference herein.

For an open loop power control, the values of several parameters are determined on the network side and signaled from the base station to a user equipment. The user equipment can then use these parameter values in addition to parameter values determined by itself for adjusting the respective uplink transmission power. The parameters provided by the base station to the user equipment include the received interference power in the base station I_{BTS} a signal-to-interference (SIR) target value for the user equipment SIR_{target}, and a constant β.

Each user equipment uses the received parameter values to calculate its transmission power P_{T,UE} from the formula:

P_{T,UE}=αL_{B}+(1−α)L₀+I_{BTS}+SIR_{target}+β

In this equation, which is based on the definitions in the above mentioned technical specification TS 25.224, α is a path loss quality factor, which is based on the most recent path loss estimate determined by the user equipment. L_{B} is the path loss determined by user equipment and measured from so-called beacon channels. L₀, finally, is the long term average path loss used to correct path loss estimate L_{B} which is based on only one measurement.

The base station thus receives signals from each physical channel with a received power P_{received} in dBm of:

P_{received}=_{BTS}+β+SIR_{target}+PC_{—}error,

where I_{BTS} is again the interference signal power level at the base station receiver in dBm, and β a TPC constant value in dB set by higher layers according to an input by the operator. The additional term PC_error is an arbitrary power control error in dB. This power control error equals to L_{real-(αL}_{B}+(1−α)L₀), where Lᵣₑₐₗ is the real path loss at the moment of reception.

The absolute value of the total power Pₜₒₜₐₗ in mW at the base station receiver is a sum over the power level P_{received} of all received physical channels:

$${P}_{total} = abs ( {I}_{BTS} ) + {\sum }_{n = 1}^{N} abs ( {P}_{received} ( n ) ) ,$$

where n indicates the respective received physical channel and N the number of received physical channels.

Since the parameters N, β, SIR_{target} and I_{BTS} determining the total power level are known in advance in the base station separately for each time slot, these values having been transmitted before to the user equipments, the received total physical channel power Pₜₒₜₐₗ can be estimated in the base station in advance, except for the arbitrary power control error for each physical channel.

The user equipments themselves try to cancel the path loss terms, which can cause some error to the received power estimate. But the user equiments determine the path loss estimates α, L₀ and L_{B} independently so that the error should be an approximately statistical FIGURE. This means that the more user equipments there are, the better the power level can be estimated, since the path loss error should average out and thus become smaller. On the other hand, when only one user equipment is transmitting to the base station receiver and carries out for this end a path loss estimation, the ADC should have enough dynamic range for dealing with a bias of some dBs in the power estimate.

The estimated total power for each time slot is then used as mentioned above to determine a gain setting value used for setting the gain applied by the AGC 2 to the received signals in order to obtain the desired power level for signals input to the ADC 1.

For estimating an expected total power for time slots where RACH can be used, the same equations are employed as for other time slots. In this case, however, it is first estimate how many RACHs there are. The number N of channels in the above equation is then adjusted according to this estimation. For normal operation, the number of channels can be estimated to be N=1, but if the receiver notices that it is rush hour and that there seem to be a lot of RACHs to receive, it can adjust the value to a larger value.

The interface between the AGC gain set and the DSP that calculates the correct gain values can be arbitrary, and the time delay can be different for different implementations. With some interfaces, the time delay may be too large for enabling an adjustment of the gain fast enough for each time slot. Therefore, gain setting values are output in the presented embodiment for several time slots at once by the write register values function 4 of the DSP and stored in the shift register 3 for immediate use. The most efficient way is to write the gain setting values for all upcoming uplink time slots during the preceding downlink time slot or slots into the shift register 3. The gain setting values can be either values indicating the desired absolute gain or values indicating a required change of the gain currently applied by the adjustable amplifier 2.

Between the different time slots, for which a dedicated gain setting value is calculated, a guard period is provided. The setting of gain for the respective next time slot is advantageously carried out during this guard period by reading the respective first gain setting value from the shift register 3.

In order to ensure that the gain values for the AGC 2 are set during the guard period between the time slots, a clock signal is provided by the guard period information function 5 of the digital part of the implementation. The clock signal changes its value when a new guard period begins. For example, it can switch to high whenever a new guard period begins and back to low at some point thereafter. Thereby this function 5 indicates to the shift register 3 that the included values are to be shifted by one position.

Thus, received signals are subjected already at the beginning of each time slot to a gain adjusted exactly to this time slot.

Even though the power level applied to the ADC 1 is quite close to the optimal value, the power level can be still more improved in steps of some dB while receiving within a time slot, if necessary, via the additional control lines including the step functions 6, 7.

The DSP provides a corresponding information to the step down or step up function 6, 7 during the current time slot, and the gain of the AGC 2 is adjusted accordingly. Alternatively, the step down function 6 and/or the step up function 7 could be controlled by some other suitable means.

The analogue RSSI 8 included in the step down function 6 of the first control line further detects the power level of the signals at the input of the ADC 1. If there is a risk that the ADC 1 will saturate, the RSSI notices this and sends a command to step down the AGC 2 by one step. Since proceeding from an already close to optimal value, the stepping algorithm does not have to compensate for large deviations of the actual power level from a desired power level and can thus lead fast enough to the desired power level. The stepping algorithm can be used in addition for determining a more accurate initial gain setting value. For example, if the gain has always to be adjusted in upward direction, this is an indication of a systematic error which can be corrected. Therefore, the output of the RSSI 8 is also forwarded to the DSP, which takes the output signal into account when determining the expected power level or the initial gain setting values.

In addition, the digital signals output by the ADC are made use of for correcting systematic gain errors in the analogue receiver chain in the gain calibration. To this end, the actual received power level is measured on the digital side by measuring means 9. The measured signal power is then provided by the measuring means 9 to the comparator 10. The comparator 10 receives as second input the expected power level that was determined according to the above equations for setting the initial gain. The comparator 10 compares the two received values, and provides the difference to the DSP. The difference is then used by the DSP as correction term in the subsequent determination of the expected power levels. When the power measurement is averaged over a certain time period, for instance over one frame, the systematic gain error can be defined and it can be added to all gain settings as a constant.

Thus, with regard to systematic gain errors a self-remediable system is obtained.

With the combination of the gain preset according to the invention and an additional employment of a stepping algorithm, a performance as good as with ADCs of a wider range can be achieved.

It is to be understood that the described structure is only one of a variety of possible embodiments of the invention and can thus be amended in any suitable way.

1. Method for controlling a gain applied to signals transmitted by a transmitting unit via an air interface and received by a receiving unit, which receiving unit has knowledge of parameter values used by said transmitting unit for setting a respective transmission power, said method comprising:
determining before reception by said receiving unit for at least some of to be received signals an expected power level in said receiving unit based on its knowledge of parameter values used by said transmitting unit for setting a transmission power for said at least some of said to be received signals; and
adjusting a gain which is to be applied to received signals for which an expected power level was determined, said gain being adjusted based on said determined expected power level.

2. Method according to claim 1, wherein for at least some of to be received signals said expected power level is determined based on parameter values employed by said at least one transmitting unit for setting the transmission power and on values measured at said receiving unit for preceding received signals.

3. Method according to one of the preceding claims, wherein said receiving unit is a base station receiver and wherein said at least one transmitting unit is at least one user equipment.

4. Method according to claim 3, wherein said signals are transmitted via the air interface in time slots of frames on physical channels, wherein said expected power level is determined based on parameter values employed by said at least one user equipment and on interference levels measured at said base station receiver, said parameter values employed by said at least one user equipment comprising at least one of the number of physical channels employed by said at least one user equipment, a signal-to-interference ratio (SIR) target assigned to each of said physical channels and one or more constant values, and said interference levels being measured on time slots of a respective preceding frame.

5. Method according to one of the preceding claims, wherein said signals are transmitted via the air interface in time slots, wherein said gain to be applied is determined individually for each time slot, wherein a gain value identifying the to be applied gain for respectively one time slot is determined for several time slots in advance, and wherein said determined gain values are stored in a register (3), the gain values being consecutively output by said register (3) for setting the gain for each time slot.

6. Method according to one of the preceding claims, wherein said signals are transmitted via the air interface in time slots.

7. Method according to claim 6, wherein said receiving unit is a receiving unit of a communications network, and wherein gain values identifying a to be applied gain for signals received in uplink time slots are provided during the transmission of signals in downlink time slots.

8. Method according to one of the preceding claims, wherein said signals are transmitted via the air interface in time slots, wherein some of said time slots are employed for at least one random access channel, wherein the current number of random access channels is estimated by said receiving unit, and wherein said determination of said expected power level in said receiving unit is based for signals transmitted in time slots employed for random access channels in addition on the estimated number of random access channels.

9. Method according to claim 8, wherein said estimation of said number of random access channels in said receiving unit takes into account the current traffic situation.

10. Method according to one of the preceding claims, wherein the power level of received signals is determined at said receiving unit and compared with said expected power level that was determined for said received signals, and wherein a resulting difference is taken into account in subsequent determinations of the power level of to be received signals for correcting systematic gain errors.

11. Method according to claim 10, wherein said received signals are converted into the digital domain after said adjusted gain was applied to them, and wherein said power level of received signals is determined and compared with said expected power level in the digital domain.

12. Method according to one of the preceding claims, wherein said adjusted gain is adjusted additionally during reception of said to be received signals with a stepping algorithm.

13. Method according to claim 12, wherein said additional adjustments of said gain by said stepping algorithm are taken into account in an adjustment of the gain for subsequently to be received signals.

14. Method according to one of the preceding claims, wherein the gain of received signals is adjusted for supplying said signals to an analogue-to-digital converter.

15. Method according to one of the preceding claims used for a wideband code division multiple access (WCDMA).

16. Receiving unit for receiving signals transmitted by a transmitting unit via an air interface, which receiving unit has knowledge of parameter values used by said transmitting unit for setting a respective transmission power for said signals and which receiving unit comprises:
an automatic gain control unit (2) for applying an adjustable gain to received signals;
means for determining in advance an expected power level of at least some of said received signals according to one of the preceding claims and
means (3,4,5) for adjusting the gain applied by said means (2) for applying a gain to received signals according to one of the preceding claims.

17. Receiving unit according to claim 16, wherein said means for adjusting the gain applied by said means (2) for applying a gain to received signals comprise a shift register (3) for storing a plurality of gain setting values determined based on said expected power level and employed in sequence for adjusting the gain applied to said received signals.

18. Receiving unit according to claim 16 or 17 which receiving unit is a base station receiver.

19. Receiving unit according to claim 16 or 17 which receiving unit is a user equipment.

20. Communications network comprising at least one receiving unit according to one of claims 16 to 18.

21. Communications system comprising at least one receiving unit according to one of claims 16 to 19.
